(19) United States
(12) Patent Application Publication
(10) Pub. No.: US 2008/0044592 A1
(43) Pub. Date: Feb. 21, 2008

(54) Method for the Chemical Functionalization of Surfaces by Plasma Polymerization

(76) Inventors: Bentsian Elkin, Stuttgart (DE); Michael Muller, Stuttgart (DE); Christian Oehr, Herrenberg (DE)

Correspondence Address: OSTROLENK FABER GERB & SOFFEN, 1180 AVENUE OF THE AMERICAS, NEW YORK, NY, 100368403, US

(21) Appl. No.: 11/720,170

(22) PCT Filed: Nov. 22, 2005
(86) PCT No.: PCT/EP05/12451

§ 371 Date: May 24, 2007

(30) Foreign Application Priority Data
Nov. 26, 2004 (DE) 10 2004 057 155.4

(51) Int. Cl. B05D 7/24

(52) U.S. Cl. 427/569

(57) ABSTRACT

The present invention relates to a process for producing chemically functionalized surfaces and/or interfaces of a functional element with the aid of plasmas, and to the functional elements thus produced.

The present invention relates to a process for producing chemically functionalized surfaces and/or interfaces of a functional element with the aid of chemically reactive plasmas, and to the functional elements thus produced.

In many applications (for example in industry, medicine or biotechnology) it is desirable or necessary that the chemical, physical or biological properties of the surface of a functional element differ from the properties of the volume of the element. In a typical case, the volume material of the functional element should be inexpensive, robust and corrosion-resistant, but the surface should fulfill further functions, for example wettability, coatability, adherability, friction behavior, biological compatibility, or capacity for particular chemical reactions. Typical examples of volume materials whose surface can be functionalized are metals, semiconductors, glasses, ceramics and polymers.

Increased wettability can be achieved, for example, by the application of hydroxyl or carboxyl groups. In order to be able to coat, for example, polymers with metals such as Cr or Al in an adhesion-resistant manner by PVD (vacuum vapor deposition), carbonyl groups are generated on the polymer surface. Desired adherability should generally be adjusted to the adhesive and can, for example, be achieved by hydroxyl, epoxy or amino groups on the surface. A biochemically neutral surface can be achieved, inter alia, by coating the surface with oligoethylene glycol chains. For numerous biochemical or medical applications, surfaces which have reactive groups such as amines, aldehydes, epoxides or carbonyls are produced. In further steps, biomolecules, for example, peptides, proteins or nucleotides, are then grafted on to these groups.

Chemical functionalizations can be obtained in various ways, for example by treatments of surfaces with liquid and gaseous reagents, by application of microscopically thick layers of other materials, as in a painting process, by plasma processes, for example by means of non-depositing plasmas, by means of plasma polymerization, or else by means of a multistage treatment which may also involve combinations of the methods mentioned.

The conventional methods for surface functionalization have significant restrictions and disadvantages. In wet-chemical methods, the type of treatment and the surface have to be adjusted to one another: for example, the frequently used route via so-called silanochemistry is possible only in the case of surfaces which have hydroxyl functions, and is therefore not directly applicable to most polymers. In the case of thick-layer application, the adhesion and stability problems have to be solved and the dimensions of the coated functional element are altered by the layer. Surfaces can be contaminated by the liquids used. The multi-stage processes often needed are associated with complicated neutralization steps and intermediate washes.

A further problem in the methods mentioned and also in standard-pressure gas phase treatment (for example, fluorination of polymer surfaces) consists in the fact that often aggressive, readily ignitable, toxic and expensive substances have to be used and disposed of in relatively large amounts.

Low-pressure plasmas have been used in recent years increasingly for the modification of surfaces of various materials for various purposes [1]. The advantages of this treatment type—including a low consumption of chemicals, a closed process sequence, the avoidance of impurities, and in many cases a rapid treatment—often outweigh the relatively high capital costs associated with low-pressure plasma technologies.

Particularly often, the “activation” of polymer surfaces is used: this forms, on the surface of a chemically inert polymer, such as polyolefins or polycarbonate, through action of non-depositing plasmas—for example Ar, O₂, air or N₂ plasmas—a mixture of different chemically active groups such as hydroxyls, carboxyls, aldehydes etc. As a result, for example, the adhesion can be significantly improved in the adhesive bonding or metalization.

The restrictions in low-pressure plasma activation include the facts that not all substrates can be activated, that the functional groups which form are very substrate-dependent, and that the surface thus formed is often relatively temporally unstable. The same also applies to plasma activation under atmospheric pressure, for example to the widespread corona process, and the process control in the case of atmospheric-pressure plasmas is even more problematic.

For some applications, for example, in the field of biotechnology, it is necessary that the surface has chemical functions essentially only of one particular type, for example, amino or hydroxyl functions. In that case, typically depositing (polymerizing) plasmas are used.

Plasma polymerization is a process in which the organic starting substance is activated in a plasma, typically in a low-pressure glow discharge, and a polymer layer forms on the substrate to be coated [1]. The activation consists in particular in the fact that the action of energy-rich species in the plasma—usually through an electron impact or an interaction with atoms or molecules in an excited metastable state—opens chemical bonds in the molecules of the starting substance, and hence forms free radicals.

Usually, the starting substance is present at atmospheric pressure and room temperature as a more or less volatile liquid. This substance is fed in vapor form into the continuously evacuated plasma reactor, and auxiliary substances, for example, a noble gas, are possibly additionally fed in, the pressure is typically adjusted within the range from a few tenths of a Pa to a few hundred Pa, the plasma is ignited by an electrical discharge, and the plasma polymerization is thus brought about.

By virtue of the suitable selection of process conditions and of precursor molecules (the starting substances for the plasma polymerization are often also known as “monomers”, even though they form the subunit of the polymer formed only to a limited degree in the plasma polymerization process—in contrast to conventional polymerization), it is possible in principle to cover substantially substrate-independent surfaces with different functional groups, and thus to obtain surfaces which have predominantly functions of a particular type.

Typically, even the precursor molecule has the functional groups with which the surface is to be functionalized. For example, carboxyl-functionalized surfaces are produced with acrylic acid plasma, amino-functionalized surfaces with allylamine or diaminocyclohexane, hydroxyl-functionalized surfaces with allyl alcohol [2], [3]. In order, for example, to prepare a plasma polymer with aldehyde function by a conventional route, the precursor selected would be a molecule which has one or more aldehyde functions and simultaneously one or more double bonds between carbon atoms, for example in the simplest case acrolein, and it would then be polymerized in a gentle manner in the plasma.

A great problem in the above-described procedure is that the action of plasma easily destroys the functional groups present in the precursor molecule. In order to avoid this, usually low plasma power densities and/or pulsed plasmas are used. This often leads to adverse consequences, such as slow treatment, a high proportion of chemically unincorporated oligomers in the layer, weak crosslinking and therefore lack of layer stability. The selection of process parameters for the production of layers which are both sufficiently stable and still have sufficient functional density is frequently very small. The establishment of the process, the process transfer to another plasma reactor, and the maintenance of reproducibility is therefore frequently associated with a high level of constant inconvenience.

The technical problem underlying the present invention is therefore the provision of a process for producing chemically functionalized surfaces and/or interfaces of functional elements, in which the destruction of desired functional groups in the precursor molecules used can be avoided by the action of plasma.

The invention solves the technical problem underlying it by the provision of a process for producing a surface of a functional element, said surface having been functionalized chemically by at least one second functional group or a group derived therefrom in further process steps, with the aid of a plasma, by, in a first step a), providing first precursor molecules, especially a substance consisting thereof or comprising them, which have or has at least one first functional group but not the second functional group, in a subsequent second step b), generating the plasma in the plasma reactor and, in a simultaneous or subsequent third step c), depositing a plasma polymer having the second functional group on the surface of the functional element, and the conversion of the first functional group to the second functional group being effected by at least one cleavage of at least one chemical bond of the first precursor molecules and subsequent termination of the resulting open bonding site by a hydrogen atom, or comprising this step. The present invention thus solves the problem underlying it by a process for chemically functionalizing surfaces by a plasma polymerization, by, in a first process step, first providing first precursor molecules which have at least one first functional group, these first precursor molecules not, however, having the functional groups, specifically the second functional groups, which are desired on the surface of the functional element and which are not deposited on the surfaces of the functional element as a constituent of the plasma polymer and hence of the coating generated until in the course of the plasma polymerization. In a second step, after provision of these first precursor molecules, the invention envisages their feeding, especially the feeding of the first substance consisting thereof or comprising them, especially in gaseous form, into a plasma reactor, and subjecting them there, in a manner customary per se, after plasma excitation, to a plasma polymerization, which forms, during the action of the plasma on the first functional groups, partly or virtually completely, second functional groups which are different from the first functional groups, and which are part of the plasma polymer deposited as a coating on the surfaces of the functional elements simultaneously or subsequently in a third step. Functional groups present on the surface and in the volume of the plasma polymer prepared in the manner described above are then at least partly, but preferably predominantly or virtually completely, the second functional groups, as do not occur in the first precursor molecules fed into the plasma polymerization in step b).

The inventive solution to the technical problem consists, inter alia, in the fact that the ultimately desired second functional group which is to be present on the coated surface and/or interface of the functional element is not present at all at first in the first precursor molecule, such that it cannot be eliminated or modified in an undesired manner. In the first precursor molecule, instead, a group, i.e. a first functional group, is present, from which the desired second functional group is formed by cleavage of particular chemical bonds and subsequent saturation of the open bond by a hydrogen atom.

The hydrogen required for the termination may (without being bound to a specific reaction mechanism) be withdrawn from the plasma, since hydrogen is present in relatively large amounts especially in plasmas which are used for plasma polymerizations, also in highly reactive forms, for example the radicals and ions H⁺, H⁻, H, H³⁺.

According to the invention, a first precursor molecule is thus understood to mean the molecule which is provided in order to be fed into the plasma polymerization process, which has at least one first chemically functional group but not the second functional group.

The plasma polymer deposited on the surface of the functional element as coating during the inventive plasma polymerization has at least one second functional group, which differs from the first functional group, and which constitutes the group which is to be applied, i.e. bonded, as the desired chemically functional group on the surface of the functional element.

In connection with the present invention, third functional groups are understood to mean those groups localized on the surface of the functional element, which after reaction of the second functional group with third molecules, form directly or after performance of intermediate steps. It may also be envisaged to generate the third functional group by oxidation or reduction from the second functional group. Such third functional groups may be chemically reactive functions, i.e. molecular moieties which are chemically reactive in a particular manner, and/or moieties which have specific biochemical, biological or other properties, for example particular wettability or friction behavior.

In the context of the present invention, a functional element is understood to mean any coatable body or coatable surface, especially composed of plastic, a polymer, a semiconductor, for example silicon, metal, ceramic, glass or the like.

In a preferred embodiment, the invention envisages that, in the first precursor molecule, the first functional group is present twice or more than twice. In a further preferred embodiment, it may be envisaged that the first precursor molecules have at least two different first functional groups. In a further preferred embodiment, it is envisaged that, in step a) of the present process, a mixture of a plurality of different first precursor molecules is used, which differ by mutually different functional first groups.

In a further preferred embodiment of the present invention, it is envisaged that the first precursor molecules are selected from the group consisting of ketones, secondary amines, secondary phosphines, ethers, thioethers, selenoethers, esters, and bicyclic compounds corresponding to oxiranes, corresponding to thiiranes or corresponding to aziridines. The first functional groups of the first precursor molecules of the present invention are therefore, in a preferred embodiment, especially keto, secondary amino, secondary phosphine, ether, thioether, selenoether, ester, non-terminal oxirane, non-terminal thiirane or non-terminal aziridine groups.

The second functional groups formed in accordance with the invention are preferably aldehyde, primary amino groups, primary phosphine groups, hydroxyl, sulfhydryl or thiol, selenol, carboxyl groups, terminal oxiranes, terminal thiiranes or terminal aziridines.

In a particularly preferred embodiment of the present invention, aldehyde groups are formed from keto groups, primary amino groups from secondary amino groups, primary phosphine groups from secondary phosphine groups, alcohol groups from ether groups, thiol groups from thioether groups, selenol groups from selenoether groups, carboxyl groups from ester groups, and terminal oxiranes, thiiranes or aziridines from bicyclic oxiranes, thiiranes or aziridines.

In a further preferred embodiment of the present invention, the first precursor molecules used are compounds with a cyclic molecular structure, preferably those without double bonds in the ring. Advantageously, it is envisaged that the cyclic precursor molecules have 3 to 8, preferably 3 to 5 ring atoms, especially carbon atoms or heteroatoms such as nitrogen atoms, sulfur atoms or oxygen atoms.

In a particularly preferred embodiment, it is envisaged that the first precursor molecules used are ketones, especially cyclic ketones, more preferably cyclopentanone, which lead to a functionalized surface of a functional element which has aldehyde groups as second functional groups.

In a further preferred embodiment, the use of ethers as the first precursor molecules is envisaged, preferably cyclic ethers, more preferably tetrahydrofuran. In this preferred embodiment, a surface is produced which comprises a hydroxyl group as the second functional group.

In a further preferred embodiment, it is envisaged that the first precursor molecules are thioethers, preferably cyclic thioethers, especially tetrathiophene. In this particularly preferred embodiment, a functionalized surface which has sulfydryl groups as the second functional group is formed.

In a further preferred embodiment, the present invention relates to an aforementioned process, wherein the first precursor molecules used are secondary amines, preferably cyclic secondary amines, especially pyrrolidine or pyrazolidine or imidazolidine. In this particularly preferred embodiment, a functionalized surface which has primary amino groups as the second functional group is formed.

In a further preferred embodiment, the present invention envisages, as the first precursor molecules, esters, preferably cyclic esters, for example β-propiolactone. In this particularly preferred embodiment, a functionalized surface which has carboxyl groups as the second functional groups is produced.

In a further preferred embodiment, the present invention relates to an aforementioned process, wherein the first precursor molecules used are secondary phosphines. In this particularly preferred embodiment, a functionalized surface which has primary phosphines as the second functional group is formed.

In a further preferred embodiment, the present invention relates to an aforementioned process, wherein the first precursor molecules used are selenoethers. In this particularly preferred embodiment, a functionalized surface which has selenol groups as the second functional group is formed.

In a further preferred embodiment, the present invention relates to an aforementioned process, wherein the first precursor molecules used are bicyclic oxiranes, aziridines or thiiranes. In this particularly preferred embodiment, a functionalized surface which has correspondingly terminal oxiranes, aziridines or thiiranes as the second functional group is formed.

In a further preferred embodiment, it is envisaged that the first precursor molecules in step b) are used in a mixture with an intrinsically non-polymerizable gas, especially hydrogen, a noble gas such as argon or a noble gas-hydrogen mixture. In a further preferred embodiment, the invention envisages that the molar concentration of the first precursor molecule in such a mixture is 20 to 80%.

In a further preferred embodiment, it is envisaged that the gas of the first precursor molecule used in b) additionally comprises at least one plasma-polymerizable second starting substance which intrinsically does not form any functional groups. It may be envisaged that, in addition to this plasma-polymerizable gas without functional groups, a non-polymerizable gas of the above-mentioned type is also additionally present.

In a further preferred embodiment, an aforementioned process is envisaged, wherein the additional plasma-polymerizable second starting substance which intrinsically does not form any functional groups is selected from the group consisting of hydrocarbons, fluorinated hydrocarbons, siloxanes and silazanes. In a preferred embodiment, this additional plasma-polymerizable second starting substance has a cyclic structure. This cyclic-structured plasma-polymerizable second starting substance may additionally have multiple bonds between carbon atoms. In a further preferred embodiment, it is envisaged that these additional plasma-polymerizable second starting substances are substances which have multiple bonds between carbon atoms without being cyclic.

In a further preferred embodiment, of the present invention, it is envisaged that the plasma excitation required in step b) is effected in the plasma reactor by an electrical alternating current discharge, the alternating current frequency being preferably in the radio frequency range, especially of 1 to 100 MHz.

In a further preferred embodiment, it is envisaged that the power density for the generation of the plasma in step b) in the plasma reactor is 0.15 to 0.5 W/cm², calculated per unit area of one of the electrodes.

In a further preferred embodiment, it is envisaged that the gas pressure in the plasma reactor in step b) is 2-200 Pa, preferably 10 to 70 Pa.

In a further particularly preferred embodiment, the invention envisages that the second functional group obtained on the interface of the functional element, especially, for example, an aldehyde, a hydroxyl, a primary amine, a primary phosphine, a thiol or a carboxyl group, after step c), is converted by a chemical, preferably wet-chemical, treatment, with third molecules such that a third functional group is obtained on the surface of the functional element directly or indirectly from the second functional group.

In a preferred embodiment of the present invention, the third molecules may be molecules bearing amino groups, especially primary and secondary amines, ammonia, hydroxylamines, diamines, hydrazine, poly- or oligoethylene glycol diamines, amino acids, peptides, proteins or monoamino-functionalized poly- or oligoethylene glycol.

The present invention thus also relates to processes of the preferred aforementioned type, wherein third molecules react with the second functional groups arranged on the surface, for example aldehyde groups, and a third functional group is formed, the third molecules which react with the second functional groups each having at least one amino group. The Schiff base formed in a preferred embodiment of this reaction can preferably be converted to a secondary amino group by a chemical reduction, for example by subsequent reaction with an alkali metal borohydride solution, especially an NaBH₄ solution, preferably an NaBH₄ solution in isopropanol, in order to bind the third molecule to the plasma polymer in a chemically stable manner.

In a further preferred embodiment, the formation of the Schiff base and its reduction to secondary amino groups is performed in a single process step by the addition of NaCNBH₃ to the second functional groups, especially the aldehyde and keto groups, and the third molecules.

In a further embodiment, the invention relates to an aforementioned procedure, wherein a functionalized surface having amino groups as the third functional groups is obtained by reaction of the second functional groups, especially of the aldehyde or keto groups, with third molecules, specifically with hydrazine or diamines, preferably with i) subsequent reduction of the Schiff bases formed, for example using an alkali metal borohydride solution, especially sodium borohydride, preferably sodium borohydride in isopropanol, or with ii) simultaneous reaction with NaCNBH₃.

In a further preferred embodiment, the present invention relates to an aforementioned process, wherein a hydrophilic surface or interface with amino groups particularly readily amenable to biochemical reactions is obtained by use of poly- or oligoethylene glycol diamine as the third molecule. In a preferred manner, it may be envisaged that the compound formed by the reaction of poly- or oligoethylene glycol diamine with the second functional groups is reduced, preferably as described under i) or ii).

In a further preferred embodiment, the present invention relates to an aforementioned process, wherein a poly- or oligoethylene glycol-functionalized surface is obtained by the reaction of the second functional groups, especially aldehyde or keto groups, with a monoamino-functionalized poly- or oligoethylene glycol as the third molecule. Subsequently or simultaneously, a reduction can be performed as described above under i) and ii).

In a further preferred embodiment, the present invention relates to an aforementioned process, wherein an amino-functionalized surface is obtained by the reaction of the second functional groups, especially the aldehyde or keto group, with third molecules, specifically with ammonia or hydroxylamine, and a preferred i) subsequent reduction of the reaction products, for example by means of alkali metal borohydride solution, especially NaBH₄ solution, preferably NaBH₄ in isopropanol, or ii) simultaneous reduction by addition of NaCNBH₃.

The present invention also relates to processes, wherein the second functional groups are oxidized on the surface of the functional element, especially the aldehyde groups, and surfaces with third functional groups which are carboxyl groups are thus formed.

In a further preferred embodiment, the present invention relates to a process, wherein the second functional groups present on the surface, for example the aldehyde groups or keto groups, are reduced, and hydroxyl groups are formed as further functional groups, i.e. a monofunctional hydroxyl-functionalized surface is obtained.

In a further preferred embodiment, the present invention relates to a process, wherein the further functional groups, especially hydroxyl groups, obtained in one of the aforementioned processes, especially a process with ether as the first molecule or a process in which aldehyde groups formed are then reduced, are reacted further on the surface by so-called silanochemistry, i.e. are reacted with silane compounds.

In a further preferred embodiment, the present invention relates to the surfaces or interfaces produced by means of the aforementioned processes, i.e. the invention therefore also relates to surfaces or interfaces producible by means of one of the processes according to the invention.

In a further preferred embodiment, the present invention also relates to functional elements produced by means of the aforementioned processes, i.e. to functional elements producible by means of one of the aforementioned processes.

Detailed description of some particularly preferred embodiments:

In the inventive solution to the problem, the precursor molecule utilized is thus, for example, cyclopentanone. In this molecule, no aldehyde but rather a keto group is present. Without being bound by the theory, it is assumed that the chemical bonds close to the carbonyl group are weaker than the other bonds in the ring, and the ring is therefore opened preferentially at this point in the plasma. The ring opening initially forms a diradical. When the opened bond of the oxygen-bonded carbon atom is terminated by a hydrogen atom—either by the reaction with a hydrogen atom from the plasma, or else by a reaction with a hydrogen-containing molecule—an aldehyde group is formed, which is then incorporated into the plasma polymer:

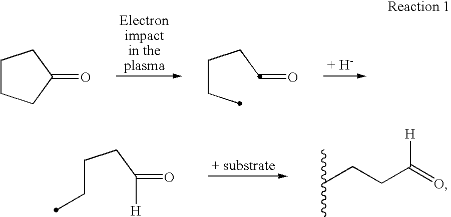

In an analogous manner, the formation used in accordance with the invention takes place

of primary amines from secondary amines such as pyrrolidine:

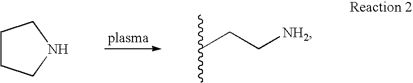

of alcohols from ethers such as tetrahydrofuran:

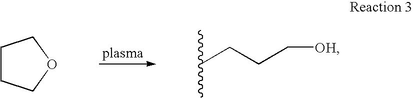

of thiols from thioethers such as tetrahydrothiophene

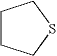

of carboxyl groups from esters such as β-propiolactone: 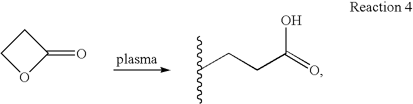
or

of terminal oxiranes (reaction 5), thiiranes (reaction 6), aziridines (reaction 7) from the corresponding bicyclic compounds:

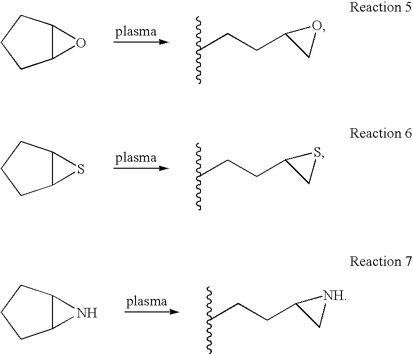

A cyclic (or bicyclic in the case of cyclic second functions, for example oxiranes) structure of the monomer is advantageous in accordance with the invention in a preferred embodiment, since such molecules, compared to molecules with a linear structure, polymerize faster in the plasma. Moreover, when only one chemical bond in the ring is opened, no molecular fragments consisting only of carbon and hydrogen form, and the density of the functional groups falls on incorporation into the plasma polymer layer.

In most of the aforementioned cases, the opening of a molecular bond on either side of the first functional group, i.e. of the relevant atom or of the group (such as the keto group in cyclopentanone or oxygen in tetrahydrofuran) leads to the formation of the desired function, i.e. of the second functional group. The larger the ring, the higher the probability that it is opened at another point, and that the desired function does not form. The smallest possible molecules are therefore preferable in accordance with the invention, preferably those having 3-8 ring atoms, especially 3-5 ring atoms, especially carbon, nitrogen, sulfur and/or oxygen atoms. Substances with smaller molecules generally also have a higher vapor pressure, which eases the introduction of the substance into the plasma reactor.

The presence of double bonds in the ring can lead to the polymerization taking place at this bond without the ring being opened and the desired second functional group being formed. According to the invention, the invention advantageously envisages, in a preferred embodiment, the use of precursor molecules which have no multiple bonds, especially no double or triple bonds. According to the invention, in a particularly preferred embodiment, precursor molecules which have a saturated ring structure with a minimum number of ring atoms are envisaged, i.e. carbon atoms or heteroatoms, for example 3 to 5 ring atoms, especially carbon atoms or heteroatoms, preferably 5.

In a preferred embodiment, the invention also envisages, as explained, the use of first precursor molecules which contain the desired first functional group to be converted not once but rather more than once, for example twice. For example, a cleavage at position three from the five ring bonds present in the pyrazolidine molecule as the first precursor molecule or at position 4 from the five ring bonds of the imidazolidine molecule as the first precursor molecule would lead to intermediates from which primary amino groups fixed on the plasma polymer surface can form (reaction 8a, b). Secondary amino groups are still formed, or some of the amines are present as a hydrazine group. For the subsequent use of the plasma polymer, this is generally irrelevant.

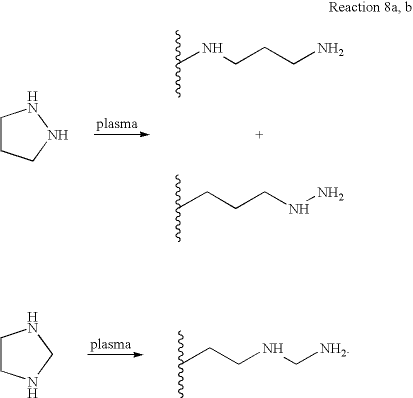

In the case of particular applications, it may be advantageous that the surface comprises chemical functions of different types simultaneously. In a further preferred embodiment, this can be achieved in accordance with the invention by virtue of the precursor molecule simultaneously comprising a plurality of different first functional groups for the desired different second functional groups. For instance, in a preferred embodiment, the generation of aldehydes and of primary amines as second functional groups can be brought about from 2-pyrrolidones as the first precursor molecule comprising, as the first functional groups, a keto group and a secondary amino group (reaction 9).

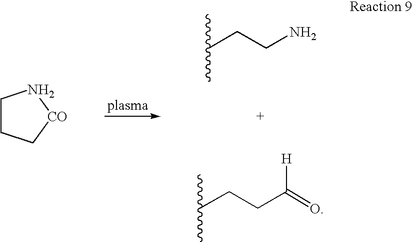

The same result in principle—the simultaneous presence of different chemical functionalities at the surface—can also be achieved in accordance with the invention in a further embodiment by the plasma polymerization of a mixture of different first precursor molecules with different first functional groups.

According to the invention, in a further preferred embodiment, further auxiliary substances are also used during the plasma polymerization proceeding in step b) apart from the inventive first precursor molecules to obtain desired functionalities:

a.—(Intrinsically) non-polymerizing gases such as noble gases or H₂ in a mixture with the first starting substance, i.e. the first precursor molecule. The addition of these gases may have an advantageous effect on the plasma stability and on the plasma polymer properties.

b.—Polymerizing substances which intrinsically do not produce any functional groups (these substances are also referred to here as second starting substances) in a mixture with the first starting substance. In this case, the concentration of the first functional groups can be varied by virtue of the adjustment of the ratio between the first starting substance, i.e. the first precursor molecule (for example cyclopentanone) and this second starting substance (for example ethane). Examples of such second starting substances are hydrocarbons, fluorinated hydrocarbons, siloxanes and silazanes. Preference is given to selecting substances whose molecules have a cyclic structure and/or have multiple bonds between carbon atoms.

c.—In a further preferred embodiment of the invention, the plasma is used in a mixture as described above under point c., to which an intrinsically non-polymerizing gas (as described in point b) is also added.

Further advantageous embodiments are evident from the subclaims.

The invention will be illustrated in detail with reference to the examples which follow and accompanying figures.

The figures show:

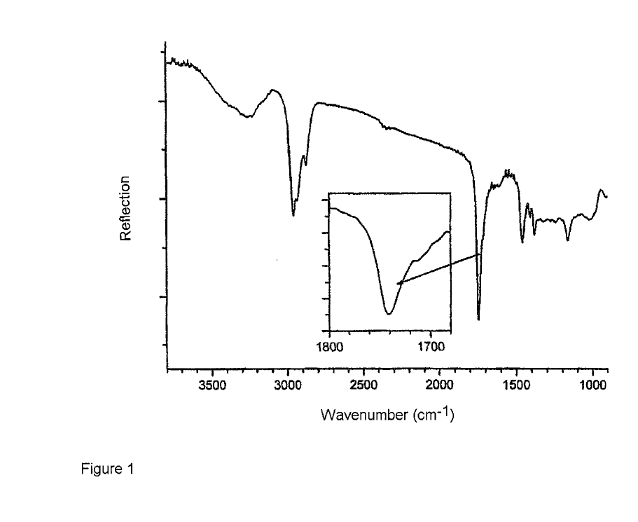

FIG. 1 an IR absorption spectrum of a cyclopentanone plasma polymer according to Example 1,

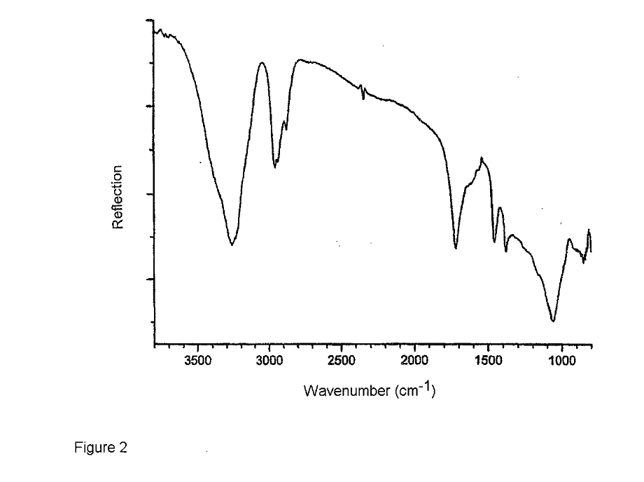

FIG. 2 an IR spectrum of a tetrahydrofuran plasma polymer according to Example 3 and

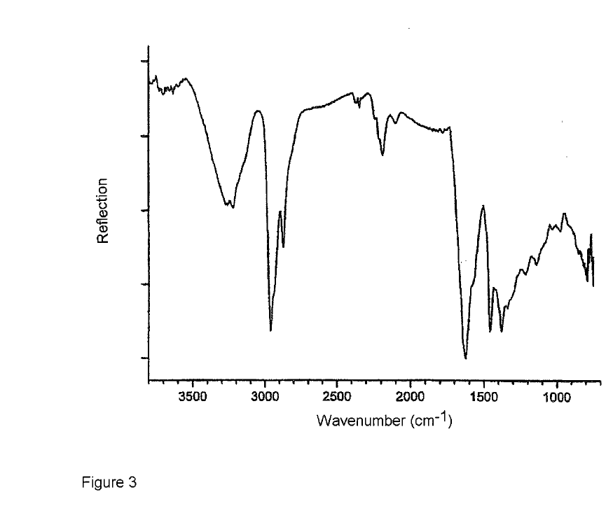

FIG. 3 an IR spectrum of a pyrrolidine plasma polymer according to Example 4.

### EXAMPLE 1

### Aldehyde-Functionalized Plasma Polymer Obtained by Means of Cyclopentanone as the First Precursor Molecule with Keto Groups as the First Functional Group

In a parallel-plate plasma reactor, the functional element to be coated (for example composed of silicon or aluminum) is placed on the grounded electrode, onto which the plasma polymer is to be deposited. The reactor is evacuated, and a mixture of argon and cyclopentanone vapor is fed in. The flow of Ar is 3 standard cubic cm per min and that of cyclopentanone 10 sccm. The pressure in the reactor is adjusted to 35 Pa. Application of a high-frequency voltage (frequency 13.56 MHz, power 60 W) ignites a plasma, and it is maintained for 5 minutes. As a result, a thin (approx. 150 nm) plasma polymer layer is deposited on the substrate. This layer was examined by means of IR spectroscopy and electron spectroscopy for chemical analysis (ESCA and XPS).

FIG. 1 shows an IR absorption spectrum of such a layer (recorded at narrow angle of incidence). The strong band in the range from approx. 1680 to 1770 cm⁻¹ indicates a high concentration of carbonyl groups. The band has a minimum at 1740 cm⁻¹ and a shoulder at approx. 1710 cm⁻¹, which indicates the presence of two forms of carbonyl groups. The absorption peak at 1740 cm⁻¹ shows a large concentration of aldehyde groups, and the shoulder at 1710 cm⁻¹ a comparatively lower concentration of keto groups in the plasma polymer. The broad absorption peak with the minimum at approx. 3250 cm⁻¹ is presumably attributable to a certain number of alcohol groups. The peak at 1160 cm⁻¹ is presumably connected to alcohol or ether groups.

Table 1 shows results of the surface analysis by means of ESCA. No carbon with 3 or 4 bonds to oxygen atoms (carboxyl, ester, carbonate) was found. Aldehyde or keto and alcohol or ether groups are present.

TABLE 1
ESCA: evaluation of the C peaks.

| | | C | C |
|---|---|---|---|
| | C 287.4 eV | 286.2 eV | 284.6 eV |
| | (carbon with two | (carbon with | (carbon |
| | bonds to oxygen atom(s): | one bond to | without |
| | aldehyde, ketone or an | oxygen atom: | bonds to |
| | —O—CH₂—O— group) | alcohol, ether) | oxygen) |
| Element | 5.2 | 8.0 | 74.0 |
| composition, | | | |
| atom percent: | | | |

The inventive use of a keto group as the first functional group led to an efficient formation of a plasma-polymerized layer comprising the desired aldehyde group as the second functional group on the functional element. In addition to the desired aldehyde group as the second functional group, comparatively small amounts of unconverted first functional groups are also still present, specifically keto groups.

### EXAMPLE 2

### Aldehyde-Functionalized Plasma Polymer, Derivatized by Wet-Chemical Means

The plasma polymer layers with predominantly aldehyde groups as the second functional groups obtained as described in Example 1 from the first precursor molecule cyclopentanone were subsequently derivatized by wet-chemical means as described below to obtain a third functional group on the surfaces of the functional element used using third molecules. One purpose of these derivatizations was to provide further proof of the reactive aldehyde groups (second functional group) on the surface of the plasma polymer. The other purpose was to obtain surfaces with specific biochemical properties.

2.1 Hydrazine Derivatization: Generation of Third Functional Groups, Specifically Amino Groups, on the Surface

Two solutions are prepared. The hydrazine solution B is a 10 mM solution of hydrazine as the third molecule in acetate buffer (820 mg of sodium acetate for 100 ml of water). The pH is adjusted to 6.9 by adding acetic acid. The reducing solution A is a saturated solution of NaBH₄ in isopropanol.

The coating obtained in Example 1 is contacted with solution B at room temperature for 1 h, then washed with isopropanol and contacted with solution A for 20 min. Thereafter, it is washed with isopropanol and repeatedly with water.

The reactions expected are:
InsolutionB—HC═O+H₂N—NH₂→HC═N—NH₂ Reaction 10
(hydrazone formation. Reaction 10 can in some cases be reversed.
InsolutionA—HC═N—NH₂+NaBH₄→—HC—NH—NH₂ Reaction 11
and
>═O+NaBH₄→>CHOH Reaction 12

The hydrazine formed as a consequence of reaction 11 is stable toward hydrolysis. In reaction 12, the unreacted keto and aldehyde groups are simultaneously converted to chemically substantially inactive alcohol groups.

In order to prove the reaction and to check the stability of the functionalization, the sample surface, after storage in acetic acid at pH 4.0 for 12 h and cleaning in water in ultrasound for 3 min (in order to remove hydrazine or hydrazone not present in thermally chemically bound form), was examined with ESCA. The amount of nitrogen measured was only 0.7 atom percent. If it is assumed that only the surface is available for reaction, and the analysis depth of the ESCA method is taken into account, the coverage of the surface is approx. 5 to 10%, a surface which would be covered with tightly packed amino groups, i.e. the desired third functional groups, being assumed for 100%.

2.2 Hydroxylamine Derivatization: Generation of Third Functional Groups, Specifically Amino Groups, on the Surface.

the solution H used consists of 1 g of hydroxylamine hydrochloride as the third molecule in 25 ml of H₂O. The pH of the solution is adjusted to 7.5 with KOH.

The plasma coating present in Example 1 is contacted with solution H at room temperature for 100 min, then washed with isopropanol and contacted with solution A for 1 h. Thereafter it is washed with isopropanol, repeatedly with water, and stored in water for 2.5 h in order to remove any nitrogen compounds which are not present in firmly chemically bound form. Subsequently, the sample was examined with ESCA.

The reactions expected are:
InsolutionH—HC═O+H₂N—OH→—HC═N—OH Reaction 13
(oxime formation).
InsolutionA—HC═N—OH+NaBH₄→—HC—NH₂ Reaction 14
and the reduction of the residual carbonyl groups after reaction 12.

The total amount of nitrogen measured was 1.4 atom percent, which corresponds to a coverage of the surface of approx. 25%. Approx. 15% of the nitrogen was in the ionized ammonium state, which provides further proof of chemically bound third functional groups, specifically amino groups, on the surface.

2.3 Diaminooligoethylene Glycol Derivatization: Generation of third functional groups, specifically amines, on the Surface.

The Jeffamine ED-600 (CAS No. 65605-36-9, Sigma-Aldrich) used is an oligoethylene glycol (OEG) with amino functions on both ends of the chain and a molecular weight of approx. 600. It is liquid at room temperature.

The coating obtained in Example 1 is contacted with Jeffamine ED-600 as the third molecules at room temperature for 60 h, then washed with isopropanol, contacted with solution A for 40 min, then washed with isopropanol and repeatedly with water. The sample surface was analyzed with ESCA.

The reactions expected are:
IntheJeffamineED-600—HC═O+H₂N—CH₂—(C₂H₄O)ₓ—CH₂—NH₂→—HC═N—CH₂—(C₂H₄O)ₓ—CH₂—NH₂ Reaction 15
(formation of possibly hydrolytically unstable Schiff bases).
InsolutionA—HC═N—CH₂—(C₂H₄O)ₓ—CH₂—NH₂+NaBH₄→—HC—NH—CH₂—(C₂H₄Oₓ—CH₂—NH₂ Reaction 16
(reduction of Schiff bases to stable secondary amines)
and the reduction of the residual carbonyl groups according to reaction 12.

The aim of the derivatization is to obtain a surface on which flexible, hydrophilic OEG chains terminated by amino groups are present as the third functional group, and are then particularly readily amenable to biochemical reactions.

The results of the ESCA analysis correspond to a surface which is 40% covered with amino-OEG, a surface covered with tightly packed OEG chains perpendicular to the surface being assumed for 100%.

In addition, the contact angle was measured for the surface described above. The advancing angle was 44°, the receding angle 27°. The corresponding values for the non-derivatized cyclopentanone plasma polymer are correspondingly 71° and 57°. The significant hydrophilization of the surface is further proof that the surface has been modified with OEG.

On the basis of the examinations detailed above, it can be stated in summary that the plasma polymer of Example 1 obtained in the manner described above has a considerable number of accessible, reactive aldehyde groups as second functional groups on the surface.

### EXAMPLE 3

### Alcohol-Functionalized Plasma Polymer Obtained by Means of Tetrahydrofuran as the First Precursor Molecule with an Ether Group as the First Functional Group

The plasma polymer is deposited using tetrahydrofuran as the starting substance. The deposition is performed in the same plasma reactor as described in Example 1. The flow of Ar is 3 sccm and that of tetrahydrofuran vapor 10 sccm, the pressure in the reactor 35 Pa, RF power 50 W, deposition time 5 min.

The plasma polymer layer was examined by means of IR spectroscopy. FIG. 2 shows the IR absorption spectrum, recorded with a narrow angle of incidence. The very strong absorption peak at 3260 cm⁻¹ and the peak at 1062 cm⁻¹ indicate a high concentration of alcohol groups as the second functional groups obtained. In addition, carbonyl groups (the absorption band at 1716 cm⁻¹) are present.

### EXAMPLE 4

### Amino-Functionalized Plasma Polymer Obtained by Means of Pyrrolidine as the First Precursor Molecule with Secondary Amino Group as the First Functional Group

The plasma polymer is deposited using pyrrolidine as the starting substance. The deposition is performed in the same plasma reactor as described in Example 1. The flow of Ar is 3 sccm and that of pyrrolidine vapor 10 sccm, the pressure in the reactor 50 Pa, RF power 60 W, deposition time 4 min.

The plasma polymer layer was examined by means of IR spectroscopy. FIG. 3 shows the IR absorption spectrum, recorded at a narrow angle of incidence. The strong peaks at 3325, 2190 and 1627 cm⁻¹ are all attributable to the presence of primary amino groups as the second functional groups obtained.

### EXAMPLE 5

### Amino-Functionalized Surfaces: Generation of Third Functional Groups, Specifically Primary Amino Groups, on the Surface

The carbonyl groups as the second functional group on the surface of a plasma polymer layer, obtained by cyclo ketone plasma polymerization according to Example 1, are reacted with an ammonia solution as the third molecules to give Schiff bases:
—HC═O+H₃N →—HC═NH Reaction 17

The Schiff bases are reduced to primary amino groups as the desired third functional groups, either subsequently by means of an NaBH₄ solution, or else in parallel with reaction 17 by the addition of NaCNBH₃ to the ammonia solution.

### EXAMPLE 6

### Surface Functionalization by Silanochemistry: Generation of Third Functional Groups on the Surface

Plasma polymerization of first precursor molecules such as cyclic ketones or cyclic ethers, as used in Example 1 or Example 3, forms a surface which has, as second functional groups, both hydroxyl and carbonyl groups (aldehyde and keto groups). The reduction of carbonyl to alcohol groups, for example with an NaBH₄ OR LiAlH₄ solution, allows a substantially monofunctional alcohol-functionalized surface to be obtained, which can then be functionalized further by the customary silanochemistry route [4].

### EXAMPLE 7

### Carboxyl-Functionalized Surfaces: Generation of Third Functional Groups, Specifically Carboxyl Groups, on the Surface

The aldehyde groups on the surface of a cyclo ketone plasma polymer, obtained according to Example 1, can be oxidized to carboxyl groups as the third functional group. The oxidation can be effected, for example, by means of a KMnO₄ or H₂Cr₂O₇ solution.

### LITERATURE

[1] Plasma polymerization/H. Yasuda.—Orlando: Academic Press, 1985.
[2] Retention of alcoholic, carboxylic and epoxy groups by polymerization of the respective precursors in pulsed glow discharges./C. Oehr et al. In: Proc. 14th International Symposium on Plasma Chemistry, Vol. IV (1999).
[3] Plasma-aminofunctionalization of PVDF-microfiltration-membranes: Comparison of the in plasma modifications with a grafting method using ESCA and an amino-selective fluorescent probe./M. Müller, C. Oehr—Surface and Coatings Technology, v. 116-119, p. 802-807 (1999).
[4] Bioconjugate techniques/G. T. Hermanson.—San Diego: Academic Press, 1996.
[5] Multifunctional thrombo-resistant coating and methods of manufacture/U.S. Pat. No. 5,342,693.

1. A process for producing a functional element which has a surface chemically functionalized by at least one second functional group or a group derived therefrom, with the aid of a plasma, by
in a first step (a), providing first precursor molecules or a first substance consisting thereof, which have/has at least one first functional group but not the second functional group,
in a second step (b), generating the plasma in a plasma reactor, and
in a third step (c), depositing a plasma polymer having the at least one second functional group on the surface of the functional element, and a conversion of the first functional group to the second functional group comprising a cleavage of at least one chemical bond of the first precursor molecules and subsequent termination of the resulting open binding site via hydrogen atoms.

2. The process according to claim 1, wherein the first functional group is present twice or more than twice in the first precursor molecules.

3. The process according to claim 1, wherein the first precursor molecules have at least two different first groups.

4. The process according to claim 1, wherein the first precursor molecules are selected from the group consisting of ketones, secondary amines, secondary phosphines, ethers, thioethers, selenoethers, esters, bicyclic aziridines, bicyclic oxiranes, and bicyclic thiiranes.

5. The process according to claim 1, wherein the first precursor molecules are compounds with cyclic molecular structure.

6. The process according to claim 5, wherein the cyclic precursor molecules have three to five ring atoms.

7. The process according to claim 1, wherein the first precursor molecules are ketones and an aldehyde-functionalized surface is produced.

8. The process according to claim 1, wherein the first precursor molecules are ethers and a hydroxyl-functionalized surface is produced.

9. The process according to claim 1, wherein the first precursor molecules are thioethers and a sulfhydryl-functionalized surface is produced.

10. The process according to claim 1, wherein the first precursor molecules are secondary amines and a surface functionalized with primary amines is produced.

11. The process according to claim 1, wherein the first precursor molecules used are esters and a surface functionalized with carboxyl groups is produced.

12. The process according to claim 1, wherein the first precursor molecules are secondary phosphines and a surface functionalized with primary phosphines is produced.

13. The process according to claim 1, wherein the first precursor molecules are selenoethers and a surface functionalized with selenol groups is produced.

14. The process according to claim 1, wherein the first precursor molecules are bicyclic oxiranes, bicyclic thiiranes or bicyclic aziridines, and a surface functionalized with terminal oxiranes, terminal thiiranes or terminal aziridines, respectively is produced.

15. The process according to claim 1, wherein the first precursor molecules or the first substance is/are used in step b) in a mixture with an intrinsically non-polymerizable gas.

16. The process according to claim 15, wherein the molar concentration of the first precursor molecules or of the first substance in the mixture is 20 to 80%.

17. The process according to claim 15, wherein the non-polymerizable gas used is hydrogen, a noble gas or a noble gas-hydrogen mixture.

18. The process according to claim 1, wherein at least one plasma-polymerizable second starting substance which intrinsically does not form any functional groups is added additionally to the first substance used in step b).

19. The process according to claim 18, wherein the at least one additional plasma-polymerizable starting substance is selected from the group consisting of hydrocarbons, fluorinated hydrocarbons, siloxanes and silazanes.

20. The process according to claim 18, wherein the at least one additional plasma-polymerizable starting substance has at least one of a cyclic structure and multiple bonds between carbon atoms.

21. The process according to claim 1, wherein a mixture of a plurality of different first precursor molecules with, in each case, different first functional groups is used in step a).

22. The process according to claim 1, wherein the plasma excitation in the plasma reactor in step b) is effected by an electrical discharge.

23. The process according to claim 22, wherein the power density for the generation of the plasma in step b) is 0.15 to 0.5 W/cm², calculated per unit area of one of the electrodes.

24. The process according to claim 1, wherein the gas pressure in the plasma reactor in step b) is 2 to 200 Pa.

25. The process according to claim 1, wherein the second functional group obtained on the surface, after step c) is converted to at least one third functional group by a chemical reaction with third molecules, directly or via further intermediate steps.

26. The process according to claim 25, wherein the third molecules which react with the second functional groups, are amino compounds.

27. The process according to claim 26, wherein a Schiff base formed by the reaction according to claim 26 is reduced chemically.

28. The process according to claim 27, wherein the chemical reduction is effected by using an alkaline metal borohydride solution.

29. The process according to claim 27, wherein the formation of the Schiff base and its chemical reduction takes place simultaneously in the reaction solution as a result of the addition of NaCNBH₃ to the reaction solution comprising third molecules.

30. The process according to claim 25, wherein an amino-functionalized surface is obtained by reaction of the second functional group with third molecules selected from the group consisting of hydrazine and diamines.

31. The process according to claim 30, wherein a hydrophilic surface with amino groups particularly readily amenable to biochemical reactions is obtained by using oligoethylene glycol diamines as the third molecules.

32. The process according to claim 25, wherein a poly- or oligoethylene glycol-functionalized surface is obtained by the reaction of the second functional group with third molecules selected from the group consisting of monoamino-functionalized poly- and oligoethylene glycols.

33. The process according to claim 25, wherein at least one of an amino-functionalized interface and surface is obtained by the reaction of the second functional group with third molecules, selected from the group consisting of ammonia and hydroxylamine.

34. The process according to claim 25, wherein the third molecules are amino acids, peptides or proteins.

35. The process according to claim 25, wherein a carboxyl-functionalized surface is obtained by oxidation of the second functional group.

36. The process according to claim 25, wherein a substantially monofunctional hydroxyl-functionalized surface is obtained by reduction of the second functional group.

37. The process according to claim 1, wherein the second or third functional group is reacted further on the surface with silane compounds.

38. A Functional element having at least one selected from the group consisting of an interface and a surface, produced by means of a process according to claim 1.
